(19) United States
(12) Patent Application Publication
(10) Pub. No.: US 2026/0025595 A1
(43) Pub. Date: Jan. 22, 2026

(54) System for Video Data Recording with Compact Image Sensor Array

(71) Applicant: Ramona Optics, Inc., Durham, NC (US)

(72) Inventors: Mark Harfouche, Durham, NC (US); Veton Saliu, Hillsborough, NC (US)

(21) Appl. No.: 19/054,784

(22) Filed: Feb. 15, 2025

Related U.S. Application Data
(60) Provisional application No. 63/672,286, filed on Jul. 17, 2024.

(51) Int. Cl. H04N 23/80; G01T 1/20; H04N 23/52; H04N 25/11; H04N 25/79

(52) U.S. Cl. CPC H04N 23/80; G01T 1/2018; H04N 23/52; H04N 25/11; H04N 25/79

(57) ABSTRACT

Disclosed is a digital imaging system comprising an array of more than one digital image sensor arranged on a single printed circuit board at a tight inter-sensor spacing that is less than the width of two adjacent image sensors. Each sensor comprises an array of light sensitive pixels that detect incident electromagnetic radiation and convert it into a digital signal. Further, a first digital processing unit is operatively connected to the electrical traces and is positioned at a finite distance from the digital image sensors to mitigate heat transfer. The first digital processing unit receives the digital signals from the sensors, aggregates them into a set of digital image data, and pre-processes the data. Moreover, a second digital processing unit then receives the pre-processed data for further processing and digital storage. Such an architecture offers enhanced image quality through improved thermal management and synchronized data aggregation.

### CROSS-REFERENCE TO RELATED APPLICATIONS

The present application claims priority to U.S. Provisional Patent Application No. 63/672,286, filed on Jul. 17, 2024 and titled System for Video Data Recording with Compact Image Sensor Array, the entire disclosure of which is incorporated herein by reference.

### FIELD OF THE INVENTION

The present invention relates to a digital imaging system comprising an array of digital image sensors mounted on a printed circuit board, a first digital processing unit configured to receive, aggregate and pre-process digital signals from the sensors and a second digital processing unit for further processing and digital storage.

### BACKGROUND OF THE INVENTION

Digital imaging systems for high-resolution image capture have become integral in scientific, medical and industrial applications, offering enhanced detail and real-time analysis. Many such systems incorporate an array of digital image sensors mounted on a printed circuit board (PCB) to capture and process electromagnetic radiation. However, despite significant advances, current imaging systems face challenges in achieving high sensor density while managing thermal dissipation, ensuring high-speed signal transmission and synchronizing sensor outputs for contiguous image acquisition. In particular, minimizing the inter-sensor spacing to achieve higher packing densities without compromising image quality or processing speed remains a critical issue.

Japanese patent document JP6030524B2 entitled “Camera system having a plurality of pixel arrays on one chip” discloses a camera system having a plurality of sensor arrays fabricated on a common substrate. Each sensor array is arranged to capture an image from incident light and is configured so that the fields of view of adjacent arrays overlap to form a substantially 360° panorama. The system further includes one or more readout circuits centrally located on the substrate, with the sensor arrays positioned along the peripheral edges of the readout circuit. While this design enhances panoramic imaging, the system fails to address challenges related to thermal management or the high-density integration of sensors on a printed circuit board for advanced digital imaging applications.

Chinese patent document CN106921820B entitled “Image sensor and camera module” discloses an image sensor and camera module comprising a substrate with a plurality of image sensor pixel arrays arranged in a row on one surface and separated by predetermined distances. The sensor pixel arrays are configured to obtain images with differing characteristics, such as black and white versus color images or images captured from lenses with varying angles of view. Although the disclosed configuration enables multi-characteristic imaging, the configuration does not resolve issues associated with tight sensor packing on a single PCB or the centralized aggregation and pre-processing of digital image data.

United States patent document U.S. Pat. No. 9,386,203B2 entitled “Compact spacer in multi-lens array module” discloses a compact spacer in a multi-lens array module. An image sensor is partitioned into multiple sensor regions, such that each sensor region receives an image focused by a corresponding lens from a proximate lens array. Further, a spacer structure is interposed between the lens array and the image sensor, surrounding the perimeter of all sensor regions such that no spacer material is disposed between any lens and its corresponding sensor region. While the disclosed design facilitates compact alignment between the lens array and the sensor, the design fails to address heat transfer challenges between processing units and sensors. The design also does not incorporate a digital processing architecture for aggregating and pre-processing image data from a densely packed sensor array.

It will be appreciated that despite the aforesaid developments, existing systems do not sufficiently resolve the critical needs for a high-density sensor array integrated on a single PCB with effective thermal management and centralized, high-speed processing.

Consequently, there exists a pressing need for an improved digital imaging system that achieves tight sensor packing, optimized thermal regulation and synchronized processing of digital image data, thereby enabling high-resolution imaging from a contiguous object plane of interest.

### SUMMARY OF THE INVENTION

To address the foregoing problems, in whole or in part, and/or other problems that may have been observed by persons skilled in the art, the present disclosure provides compositions and methods as described by way of example as set forth below.

In one aspect, a digital imaging system is provided. The system comprises an array of more than one digital image sensor arranged on a single printed circuit board (PCB) at a tight inter-sensor spacing. The inter-sensor spacing is less than the width of two adjacent image sensors. Each digital image sensor comprises an array of light sensitive pixels configured to detect incident electromagnetic radiation and convert the detected electromagnetic radiation into a digital signal. The system further comprises a first digital processing unit operatively connected to a plurality of electrical traces, which is positioned at a finite distance from the digital image sensors to mitigate heat transfer and is configured to receive the digital signals from the digital image sensors, aggregate these signals into a set of digital image data, and pre-process the set of digital image data. The system also includes a second digital processing unit configured to receive the pre-processed digital image data from the first digital processing unit for further processing and digital storage. This arrangement achieves improved thermal management and efficient high-speed data processing in a densely packed sensor array.

In an embodiment, the PCB comprises a plurality of electrical traces patterned thereon, which are electrically coupled to each of the digital image sensors. Each electrical trace is configured to carry the digital signals representing the detected electromagnetic radiation as well as one or more digital control signals that define operating properties of the digital image sensors. This design ensures reliable signal transmission and precise sensor control.

In another embodiment, each digital image sensor is configured to detect incident electromagnetic radiation associated with visible, ultraviolet, near-infrared, or infrared portions of the electromagnetic spectrum. This capability provides versatile imaging across a broad range of wavelengths.

In yet another embodiment, at least one digital image sensor is coated with a filter selected from the group consisting of a fluorescence emission filter and a color filter arranged in a Bayer pattern. The filter selectively passes a predetermined spectral component of the incident electromagnetic radiation, thereby enhancing image quality by isolating desired wavelengths.

In still another embodiment, the at least one digital image sensor is coated with a homogeneous or inhomogeneous filter material covering the entire image sensor. The filter material filters the incident electromagnetic radiation in a spectral manner, a polarimetric manner, or both, thereby improving capture fidelity under varying lighting conditions.

In a further embodiment, at least one digital image sensor is coated with a scintillator material configured to convert incident X-ray radiation into fluorescence emission that is subsequently detected by the digital image sensor. This configuration enables effective detection and processing of X-ray radiation.

In another embodiment, the first digital processing unit comprises one or more field-programmable gate arrays (FPGAs) mounted on a secondary printed circuit board. The secondary printed circuit board is electrically connected via high-speed electrical connectors to the PCB bearing the array of digital image sensors, thereby facilitating rapid data communication and processing.

In yet another embodiment, the PCB comprises a multi-layer stackup having a plurality of high-speed electrical traces distributed over the layers, with each layer sandwiched between ground planes that serve as heat sinks to reduce temperature rise in the digital image sensors. This configuration enhances thermal dissipation and maintains signal integrity.

In still another embodiment, the aggregated set of digital image data comprises multiple image frames acquired as a function of time, with the multiple image frames constituting one or more video streams. This enables dynamic video capture and real-time imaging applications.

In a further embodiment, the first digital processing unit is further configured to perform digital image processing selected from a group consisting of noise reduction, lossless image compression, lossy image compression, region-of-interest selection, feature selection, image comparison, and image stitching. This capability enhances image quality and enables efficient data management.

In another embodiment, the first digital processing unit is further configured to send one or more digital control signals to the digital image sensors to define operating properties thereof, while the second digital processing unit is further configured to send digital instructions to the first digital processing unit for forming programmable logical blocks therein. This arrangement provides flexibility in system control and dynamic reconfiguration of processing tasks.

In yet another embodiment, the system is configured for one of multiple imaging configurations selected from a group consisting of diffracted electromagnetic radiation detection, multi-lens imaging configuration, and single-lens imaging configuration. The imaging configuration provides a high-resolution image from a contiguous object plane of interest. This versatility enables adaptation to various imaging applications.

In still another embodiment, the PCB comprises a three-dimensional structure including a sensor board and a secondary processing board. The sensor board has a top side for mounting the digital image sensors and a bottom side having milled channels for accommodating passive components, while the secondary processing board, onto which the first digital processing unit is mounted, is soldered onto exposed pads in unmilled sections of the sensor board. This three-dimensional structure minimizes the overall system footprint and optimizes component placement.

In a further embodiment, the system further comprises a thermal management mechanism configured to mitigate heat accumulation at the digital image sensors and along the electrical traces. The thermal management mechanism comprises at least one of multiple ground planes, exposed copper regions, heat sinks, forced air cooling, and an array of heat pipes. This mechanism effectively manages heat dissipation, thereby enhancing system stability and performance.

In another aspect, a method of digital imaging is provided. The method comprises arranging an array of more than one digital image sensor on a single printed circuit board (PCB) at a tight inter-sensor spacing that is less than the width of two adjacent image sensors, wherein each digital image sensor comprises an array of light sensitive pixels configured to detect incident electromagnetic radiation and convert the detected electromagnetic radiation into a digital signal. The method further comprises positioning a first digital processing unit at a finite distance from the digital image sensors to mitigate heat transfer. The first digital processing unit is configured to receive the digital signals from the digital image sensors via electrical traces patterned on the PCB, aggregate the received digital signals into a set of digital image data, and pre-process the set of digital image data, and finally directing the pre-processed digital image data from the first digital processing unit to a second digital processing unit for further processing and digital storage. This method provides efficient image data acquisition with enhanced thermal management and synchronized processing.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

Having thus described the subject matter of the present invention in general terms, reference will now be made to the accompanying drawings, which are not necessarily drawn to scale, and wherein:

FIG. 1 shows a schematic illustration of a prior art camera array system;

FIGS. 2A-B show schematic illustrations of a digital imaging system incorporating a centralized processing architecture, in accordance with various embodiments of the present disclosure;

FIG. 3 shows a detailed schematic illustration of a digital image sensor array incorporating filtered pixels, in accordance with an embodiment of the present disclosure;

FIG. 4 shows a schematic illustration of digital image sensors with different filter and scintillator coatings, in accordance with an embodiment of the present disclosure;

FIG. 5 shows a schematic diagram illustrating the interaction of incident electromagnetic radiation with a digital image sensor array, in accordance with an embodiment of the present disclosure;

FIG. 6 shows a schematic illustration of a digital image sensor array system with an integrated lens system and processing units, in accordance with an embodiment of the present disclosure;

FIG. 7 shows a schematic illustration of an image sensor array system with an integrated lens system and processing units, in accordance with an embodiment of the present disclosure;

FIG. 8 shows a schematic diagram illustrating an image sensor array system with a microlens array and processing units, in accordance with an embodiment of the present disclosure;

FIG. 9 shows a cross-sectional view of a folded PCB design incorporating a compact arrangement of digital image sensors and a first digital processing unit, in accordance with an embodiment of the present disclosure;

FIG. 10 shows a cross-sectional view of a folded PCB design incorporating multiple digital image sensors and an FPGA-based first digital processing unit 1008, in accordance with an embodiment of the present disclosure;

FIG. 11 shows a cross-sectional view of a folded PCB design incorporating multiple digital image sensors and a dual FPGA-based first digital processing unit, in accordance with an embodiment of the present disclosure; and

FIG. 12 shows a flowchart of a method of digital imaging, in accordance with an embodiment of the present disclosure.

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As described more fully below, the present disclosure is directed to a digital imaging system comprising an array of digital image sensors mounted on a printed circuit board, a first digital processing unit configured to receive, aggregate and pre-process digital signals from the sensors and a second digital processing unit for further processing and digital storage. The system provides high sensor packing density, efficient thermal management and versatile imaging configurations.

In one aspect, a digital imaging system is provided. The system comprises an array of more than one digital image sensor arranged on a single printed circuit board (PCB) at a tight inter-sensor spacing. The inter-sensor spacing is less than the width of two adjacent image sensors. Each digital image sensor comprises an array of light sensitive pixels configured to detect incident electromagnetic radiation and convert the detected electromagnetic radiation into a digital signal. The system further comprises a first digital processing unit operatively connected to a plurality of electrical traces, which is positioned at a finite distance from the digital image sensors to mitigate heat transfer and is configured to receive the digital signals from the digital image sensors, aggregate these signals into a set of digital image data, and pre-process the set of digital image data. The system also includes a second digital processing unit configured to receive the pre-processed digital image data from the first digital processing unit for further processing and digital storage. This arrangement achieves improved thermal management and efficient high-speed data processing in a densely packed sensor array.

In an embodiment, the PCB comprises a plurality of electrical traces patterned thereon, which are electrically coupled to each of the digital image sensors. Each electrical trace is configured to carry the digital signals representing the detected electromagnetic radiation as well as one or more digital control signals that define operating properties of the digital image sensors. This design ensures reliable signal transmission and precise sensor control.

In another embodiment, each digital image sensor is configured to detect incident electromagnetic radiation associated with visible, ultraviolet, near-infrared, or infrared portions of the electromagnetic spectrum. This capability provides versatile imaging across a broad range of wavelengths.

In yet another embodiment, at least one digital image sensor is coated with a filter selected from the group consisting of a fluorescence emission filter and a color filter arranged in a Bayer pattern. The filter selectively passes a predetermined spectral component of the incident electromagnetic radiation, thereby enhancing image quality by isolating desired wavelengths.

In still another embodiment, the at least one digital image sensor is coated with a homogeneous or inhomogeneous filter material covering the entire image sensor. The filter material filters the incident electromagnetic radiation in a spectral manner, a polarimetric manner, or both, thereby improving capture fidelity under varying lighting conditions.

In a further embodiment, at least one digital image sensor is coated with a scintillator material configured to convert incident X-ray radiation into fluorescence emission that is subsequently detected by the digital image sensor. This configuration enables effective detection and processing of X-ray radiation.

In another embodiment, the first digital processing unit comprises one or more field-programmable gate arrays (FPGAs) mounted on a secondary printed circuit board. The secondary printed circuit board is electrically connected via high-speed electrical connectors to the PCB bearing the array of digital image sensors, thereby facilitating rapid data communication and processing.

In yet another embodiment, the PCB comprises a multi-layer stackup having a plurality of high-speed electrical traces distributed over the layers, with each layer sandwiched between ground planes that serve as heat sinks to reduce temperature rise in the digital image sensors. This configuration enhances thermal dissipation and maintains signal integrity.

In still another embodiment, the aggregated set of digital image data comprises multiple image frames acquired as a function of time, with the multiple image frames constituting one or more video streams. This enables dynamic video capture and real-time imaging applications.

In a further embodiment, the first digital processing unit is further configured to perform digital image processing selected from a group consisting of noise reduction, lossless image compression, lossy image compression, region-of-interest selection, feature selection, image comparison, and image stitching. This capability enhances image quality and enables efficient data management.

In another embodiment, the first digital processing unit is further configured to send one or more digital control signals to the digital image sensors to define operating properties thereof, while the second digital processing unit is further configured to send digital instructions to the first digital processing unit for forming programmable logical blocks therein. This arrangement provides flexibility in system control and dynamic reconfiguration of processing tasks.

In yet another embodiment, the system is configured for one of multiple imaging configurations selected from a group consisting of diffracted electromagnetic radiation detection, multi-lens imaging configuration, and single-lens imaging configuration. The imaging configuration provides a high-resolution image from a contiguous object plane of interest. This versatility enables adaptation to various imaging applications.

In still another embodiment, the PCB comprises a three-dimensional structure including a sensor board and a secondary processing board. The sensor board has a top side for mounting the digital image sensors and a bottom side having milled channels for accommodating passive components, while the secondary processing board, onto which the first digital processing unit is mounted, is soldered onto exposed pads in unmilled sections of the sensor board. This three-dimensional structure minimizes the overall system footprint and optimizes component placement.

In a further embodiment, the system further comprises a thermal management mechanism configured to mitigate heat accumulation at the digital image sensors and along the electrical traces. The thermal management mechanism comprises at least one of multiple ground planes, exposed copper regions, heat sinks, forced air cooling, and an array of heat pipes. This mechanism effectively manages heat dissipation, thereby enhancing system stability and performance.

In another aspect, a method of digital imaging is provided. The method comprises arranging an array of more than one digital image sensor on a single printed circuit board (PCB) at a tight inter-sensor spacing that is less than the width of two adjacent image sensors, wherein each digital image sensor comprises an array of light sensitive pixels configured to detect incident electromagnetic radiation and convert the detected electromagnetic radiation into a digital signal. The method further comprises positioning a first digital processing unit at a finite distance from the digital image sensors to mitigate heat transfer. The first digital processing unit is configured to receive the digital signals from the digital image sensors via electrical traces patterned on the PCB, aggregate the received digital signals into a set of digital image data, and pre-process the set of digital image data, and finally directing the pre-processed digital image data from the first digital processing unit to a second digital processing unit for further processing and digital storage. This method provides efficient image data acquisition with enhanced thermal management and synchronized processing.

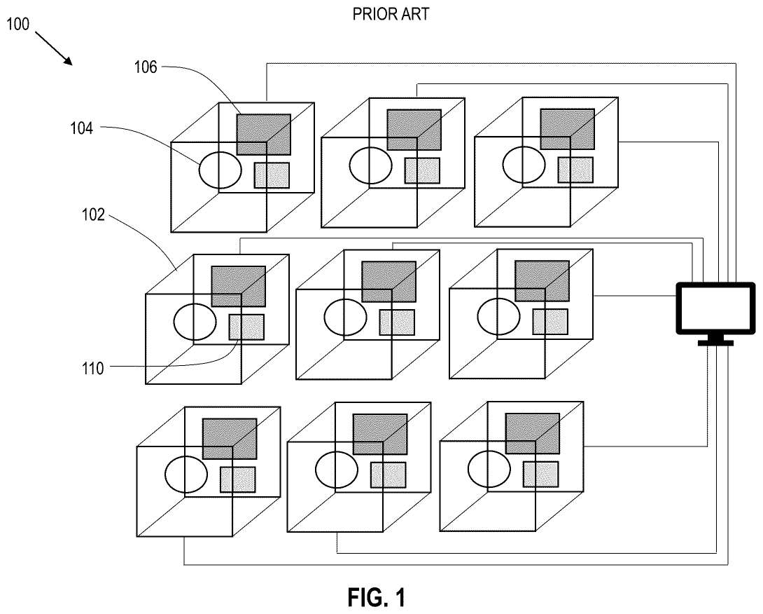

Referring to FIG. 1, there is shown a schematic illustration of a prior art camera array system 100. The prior art camera system 100 illustrates a conventional approach to multi-sensor imaging. The prior art camera array system 100 comprises a plurality of individual camera modules 102, each having a digital image sensor 104 and a dedicated processing unit 106. The camera modules 102 are spaced apart on a support structure (not shown), with each camera module 102 operating independently, capturing image data and performing localized processing before transmitting the processed data to an external computing system 108.

Each digital image sensor 104 within the camera modules 102 comprises an array of light-sensitive pixels 110 configured to detect incident electromagnetic radiation and convert the detected radiation into digital signals. However, due to the discrete nature of the camera modules 102, the inter-sensor spacing is relatively large, resulting in gaps between adjacent image capture areas. This arrangement necessitates complex image stitching algorithms to create a continuous composite image, often leading to artifacts and inconsistencies in spatial alignment.

The dedicated processing units 106 integrated within each camera module 102 introduce additional challenges, particularly with respect to thermal management. Since each processing unit 106 is co-located with its corresponding digital image sensor 104, heat dissipation becomes a significant issue, leading to increased sensor noise and degraded image quality. Additionally, the decentralized processing architecture of the prior art camera array system 100 results in asynchronous image acquisition, making it difficult to achieve precise temporal alignment across multiple sensors.

The prior art camera array system 100 further comprises an external computing system 108 that receives the processed image data from the individual camera modules 102. Due to the independent nature of the modules 102, the external computing system 108 must perform extensive post-processing, including time synchronization, spatial registration, and data aggregation. This increases computational overhead and introduces latency, limiting the real-time performance of the system.

In summary, the prior art camera array system 100 suffers from several limitations, including large inter-sensor spacing, inefficient thermal management, asynchronous image acquisition, and high post-processing complexity. These limitations impact the overall system performance, making it unsuitable for applications requiring seamless, high-resolution, and real-time imaging. The present disclosure addresses these challenges by introducing a closely spaced sensor array with centralized processing, as described in subsequent figures.

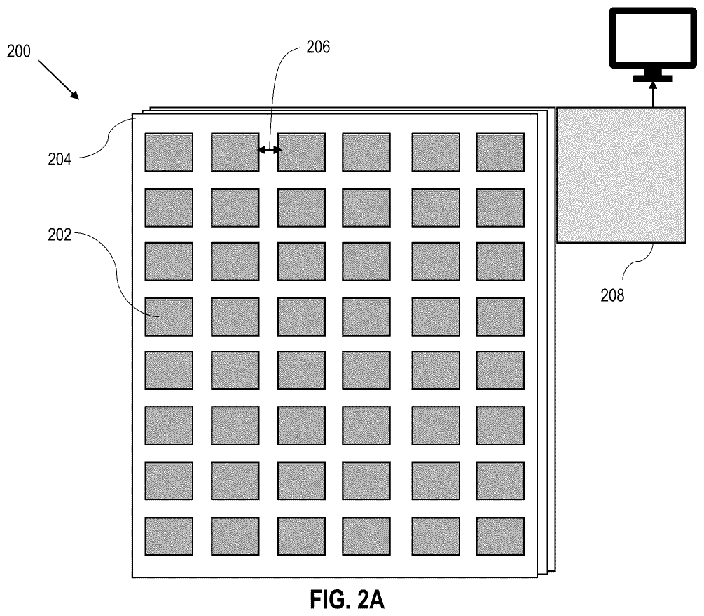

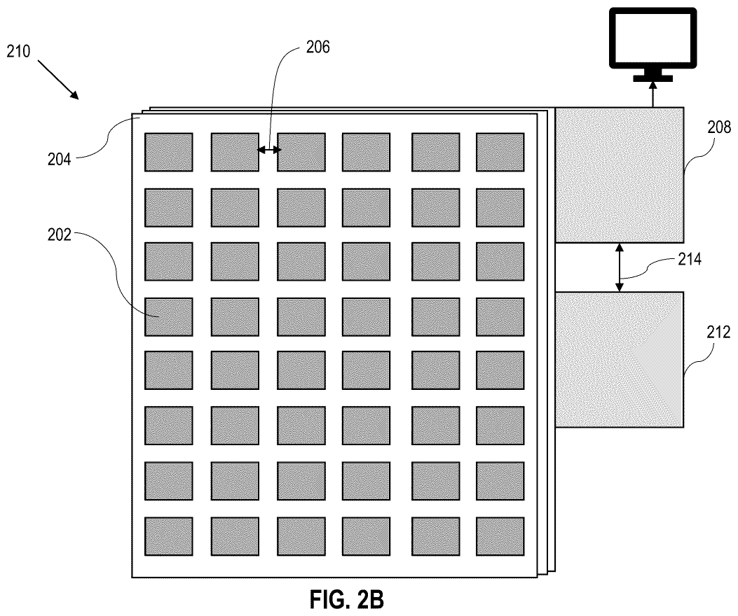

Referring to FIGS. 2A-B, there are shown schematic illustrations of a digital imaging system 200-210 incorporating a centralized processing architecture, in accordance with various embodiments of the present disclosure. As shown in FIG. 2A, the digital imaging system 200 comprises an array of more than one digital image sensor 202 arranged on a single printed circuit board (PCB) 204 at a tight inter-sensor spacing 206. The inter-sensor spacing 206 is less than the width of two adjacent image sensors 202, thereby enabling a high packing density. Such an arrangement minimizes spatial gaps between adjacent sensors, thereby improving spatial continuity in the captured image data and reducing the need for computational image stitching.

Each digital image sensor 202 comprises an array of light-sensitive pixels that are configured to detect incident electromagnetic radiation and convert the detected radiation into a digital signal. The digital image sensors 202 may be configured to detect electromagnetic radiation across visible, ultraviolet, near-infrared, or infrared portions of the electromagnetic spectrum. This spectral adaptability enables the imaging system 200 to be deployed in a wide range of applications, including biomedical imaging, industrial inspection, and scientific instrumentation.

The system 200 further comprises a first digital processing unit 208, which is operatively connected to a plurality of electrical traces 208 patterned on the PCB 204. The first digital processing unit 208 is positioned at a finite distance from the digital image sensors 202 to mitigate heat transfer therebetween. Unlike conventional designs where each sensor has a dedicated processing unit (as shown in FIG. 1), the centralized processing unit 206 aggregates digital signals from all the sensors 202 and processes them collectively. This architecture significantly reduces the power dissipation near the sensor array and minimizes thermal noise that could otherwise degrade image quality.

The first digital processing unit 208 is configured to receive the digital signals from the digital image sensors 202, aggregate the received digital signals into a set of digital image data, and pre-process the set of digital image data. The pre-processing functions include, but are not limited to, noise reduction, pixel-level corrections, and region-of-interest selection. Pre-processing at the first digital processing unit 208 allows for efficient data handling before the image data is transmitted to the next stage of processing.

Referring now to FIG. 2B, the system 210 further comprises a second digital processing unit 212 configured to receive the pre-processed digital image data from the first digital processing unit 208 for further processing and digital storage. The second digital processing unit 212 is responsible for high-level computations such as image stitching, object detection, and data compression. In applications requiring real-time imaging, the second digital processing unit 212 ensures that high-resolution video streams can be processed and analyzed with minimal latency.

In an embodiment, the printed circuit board 204 comprises a plurality of electrical traces 208 that are electrically coupled to each of the digital image sensors 202. Each electrical trace 208 is configured to carry the digital signals representing the detected electromagnetic radiation and one or more digital control signals that define operating properties of the digital image sensors 202. The digital control signals enable dynamic adjustments to exposure time, gain, frame rate, and pixel sub-sampling strategies, allowing the imaging system 200 to be optimized for different imaging conditions.

In another embodiment, the first digital processing unit 208 comprises one or more field-programmable gate arrays (FPGAs) mounted on a secondary printed circuit board (not shown) that is electrically connected to the PCB 204 via high-speed electrical connectors 214. The FPGA-based implementation allows for parallel processing of image data from multiple sensors 202, enabling real-time data aggregation and processing. The use of high-speed electrical connectors 214 ensures minimal signal degradation and enables efficient communication between the sensor array and the processing units.

In yet another embodiment, the PCB 204 comprises a multi-layer stackup having a plurality of high-speed electrical traces distributed over the layers, wherein each layer is sandwiched between ground planes that serve as heat sinks to reduce temperature rise in the digital image sensors 202. This layered PCB structure provides efficient thermal dissipation, ensuring that the sensors 202 operate within optimal temperature ranges and reducing thermal noise in the acquired images.

Additionally, the aggregated set of digital image data comprises multiple image frames acquired as a function of time, wherein the multiple image frames constitute one or more video streams. The ability to generate synchronized video streams from a tightly packed sensor array provides a significant advantage in applications requiring high-speed imaging, such as motion analysis and industrial monitoring.

Overall, the configuration illustrated in FIG. 2 represents a significant advancement over prior art designs by integrating a centralized processing unit, reducing thermal interference, and improving synchronization across the sensor array. By employing a high-density PCB layout, efficient data aggregation techniques, and FPGA-based processing, the digital imaging system 200 achieves superior image quality, high-speed data transmission, and enhanced computational efficiency.

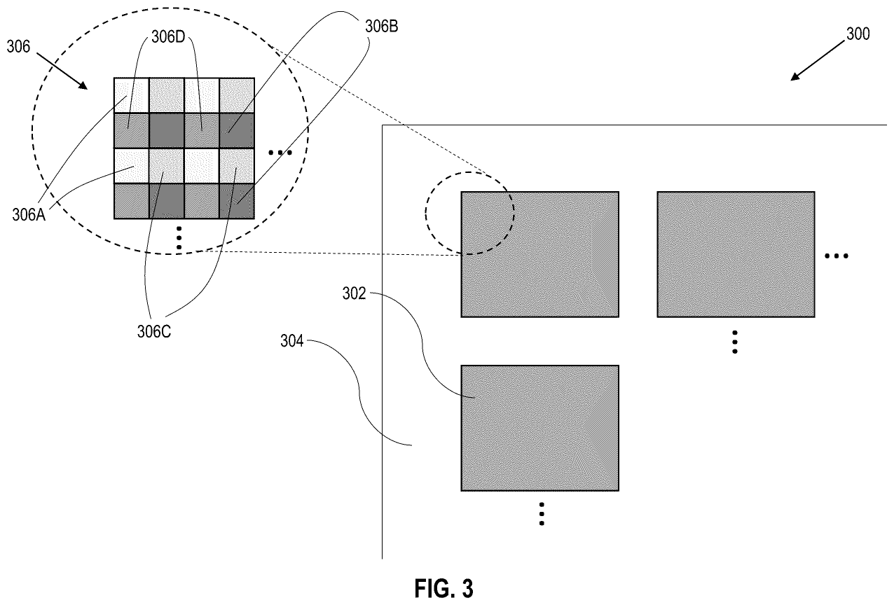

Referring to FIG. 3, there is shown a detailed schematic illustration of a digital image sensor array 300 incorporating filtered pixels 306, in accordance with an embodiment of the present disclosure. The digital image sensor array 300 comprises a plurality of digital image sensors 302 arranged at a tight inter-sensor spacing on a single printed circuit board (PCB) 304. Each digital image sensor 302 comprises an array of light-sensitive pixels 306, wherein individual pixels are coated with different types of filters to selectively transmit specific components of incident electromagnetic radiation.

Each light-sensitive pixel 306 is configured to detect electromagnetic radiation within a particular spectral range, allowing the system 300 to capture multispectral or hyperspectral image data. In an embodiment, at least one digital image sensor 302 is coated with a filter selected from a group consisting of a fluorescence emission filter and a color filter arranged in a Bayer pattern. The fluorescence emission filter selectively transmits light within a specific fluorescence band, which is advantageous for biological and medical imaging applications. The Bayer pattern filter consists of red, green, and blue (RGB) filters arranged in a periodic array, facilitating natural color image reconstruction.

In another embodiment, at least one digital image sensor 302 is coated with a homogeneous or inhomogeneous filter material covering the entire sensor. The homogeneous filter material enables the entire sensor to capture light within a predefined spectral or polarization range, whereas an inhomogeneous filter material provides spatially varying spectral sensitivity across the sensor array. This capability is particularly useful in imaging applications requiring selective detection of polarized light or narrow spectral bands.

Further, the light-sensitive pixels 306 of the digital image sensor array 300 are arranged in a repeating pattern, wherein pixel 306A is filtered by a first filter type, pixel 306B is filtered by a second filter type, pixel 306C is filtered by a third filter type, and pixel 306D is filtered by a fourth filter type. This periodic arrangement ensures that all spectral components of the incident radiation are captured efficiently while maintaining a high spatial resolution. Such a configuration enhances imaging quality and enables sophisticated computational imaging techniques, such as spectral unmixing and feature extraction.

In an additional embodiment, the filtering mechanism may be adapted to support application-specific requirements, such as biomedical fluorescence imaging, industrial material inspection, and remote sensing. The use of precisely engineered optical filters improves the signal-to-noise ratio of the captured image data by minimizing unwanted background radiation. Moreover, by integrating the filters directly onto the digital image sensors 302, the system eliminates the need for external filter wheels or complex optical assemblies, thereby reducing mechanical complexity and improving robustness.

Overall, the digital image sensor array 300 enhances the capability of multispectral and hyperspectral imaging by incorporating integrated filtering solutions. The high-density arrangement of sensors, combined with specialized filtering mechanisms, ensures superior spectral selectivity, improved signal quality, and expanded application possibilities for the imaging system.

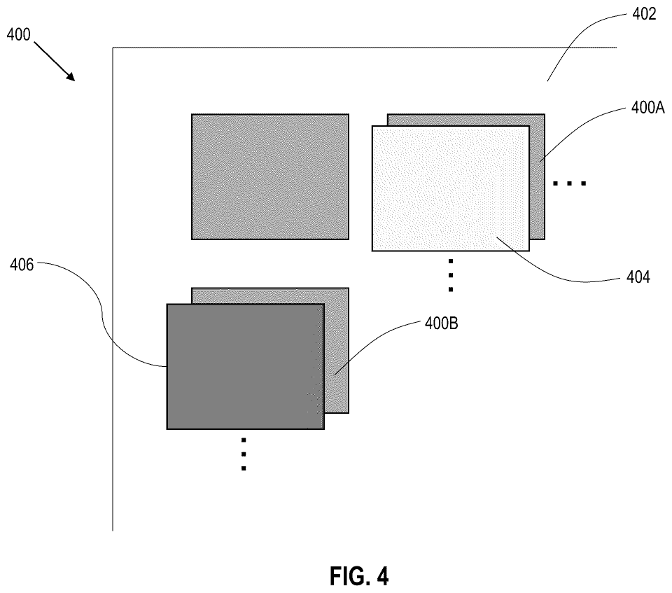

Referring to FIG. 4, there is shown a schematic illustration of digital image sensors 400 with different filter and scintillator coatings, in accordance with an embodiment of the present disclosure. The digital image sensors 400 are arranged at a tight inter-sensor spacing on a printed circuit board (PCB) 402, wherein each digital image sensor 400 comprises an array of light-sensitive pixels. Unlike conventional image sensor arrays that rely on external optical elements, the present embodiment integrates spectral and scintillator coatings directly onto individual sensors, enabling enhanced imaging capabilities tailored to specific application requirements.

In an embodiment, at least one digital image sensor 400 is coated with a homogeneous or inhomogeneous filter material covering the entire sensor. The homogeneous filter material enables uniform spectral selection across the sensor, while the inhomogeneous filter material provides spatially varying spectral sensitivity. Such a configuration is beneficial for applications requiring polarization-sensitive imaging or variable spectral discrimination across the sensor array.

As shown, one digital image sensor 400A is covered by an example filter 404 such that all pixels receive radiation that has been spectrally or polarimetrically filtered. This filtering mechanism enables selective detection of specific spectral components, such as fluorescence emissions, near-infrared reflectance, or polarized light from anisotropic materials. Such filtering is critical in applications such as biomedical imaging, material analysis, and remote sensing, where spectral discrimination is essential for accurate data acquisition.

In another embodiment, at least one digital image sensor 400B is coated with a scintillator material 406. The scintillator material 406 is configured to convert incident X-ray radiation into fluorescence emission, which is subsequently detected by the underlying digital image sensor 400B. This configuration allows the imaging system to capture X-ray images with high sensitivity while leveraging the digital image sensor array for efficient signal detection. Example scintillator materials include cesium iodide (CsI), gadolinium oxysulfide (GOS), and terbium-doped phosphors, each offering specific advantages in terms of light yield and conversion efficiency.

The integration of scintillator coatings onto digital image sensors 400B enables compact, high-resolution X-ray imaging without requiring bulky external scintillator panels. Such an approach enhances the spatial resolution of the acquired X-ray images and reduces optical losses associated with traditional indirect detection methods. Moreover, by utilizing a tightly packed sensor array, the system minimizes inter-pixel gaps, thereby improving the uniformity and accuracy of the X-ray imaging process.

In an additional embodiment, multiple digital image sensors 400 within the array may be configured with different filtering and scintillator coatings, allowing for simultaneous multispectral and X-ray imaging. Such a hybrid imaging capability is highly advantageous in medical diagnostics, security screening, and industrial inspection, where both visible and X-ray imaging modalities are required for comprehensive analysis.

Overall, the digital image sensor array 400 introduces an innovative approach to spectral and X-ray imaging by integrating advanced filter and scintillator coatings directly onto the sensors. This design enhances the versatility of the imaging system, enabling high-performance imaging across multiple spectral domains while maintaining a compact and thermally efficient architecture.

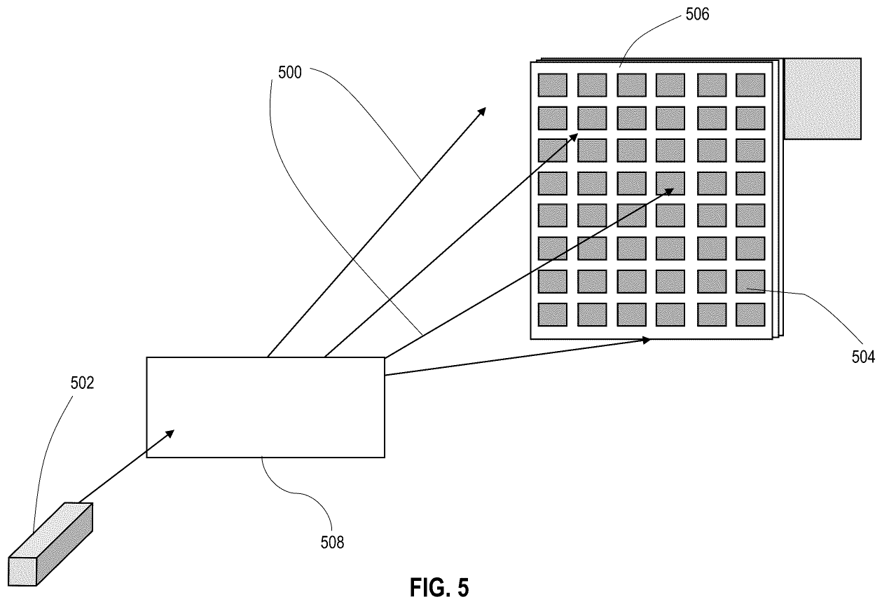

Referring to FIG. 5, there is shown a schematic diagram illustrating the interaction of incident electromagnetic radiation 500 with a digital image sensor array 502, in accordance with an embodiment of the present disclosure. As shown, the electromagnetic radiation 500 is emitted by a radiation source 502. The figure shows a comprehensive view of how incoming radiation is detected, filtered, and processed within the tightly packed sensor array, thereby enabling high-resolution imaging across multiple spectral bands.

The digital image sensor array comprises more than one digital image sensor 504 arranged at a tight inter-sensor spacing on a printed circuit board (PCB) 506. Each digital image sensor 504 in the array is configured to detect and convert incident electromagnetic radiation 500 into a digital signal. The system is designed to capture radiation across different regions of the electromagnetic spectrum, including visible, ultraviolet, near-infrared, and infrared radiation. This capability allows the imaging system to be adapted for various applications, such as biomedical imaging, industrial inspection, remote sensing, and scientific analysis.

In an embodiment, at least one digital image sensor 506 is coated with a homogeneous or inhomogeneous filter material covering its entire surface. Such a coating enables selective filtering of the incident electromagnetic radiation 500 in a spectral or polarimetric manner, or both. This selective filtering enhances image contrast by isolating specific spectral components, making it useful for multispectral or hyperspectral imaging applications.

In another embodiment, at least one digital image sensor 504 is coated with a scintillator material. The scintillator material is configured to convert incident high-energy radiation, such as X-rays, into visible fluorescence emission, which is subsequently detected by the digital image sensor 504. This arrangement is particularly useful for X-ray imaging applications, where direct photon detection by standard CMOS or CCD sensors is not feasible. Example scintillator materials include cesium iodide (CsI), gadolinium oxysulfide (GOS), and terbium-doped phosphors, which provide efficient conversion of high-energy radiation into detectable light.

The tightly packed arrangement of digital image sensors 504 within the array ensures minimal loss of spatial resolution when detecting incoming radiation 500. Unlike traditional imaging systems that require bulky optical elements and external filter wheels, the present system integrates spectral and scintillator coatings directly onto the sensor surfaces, thereby eliminating mechanical complexity and improving imaging robustness.

In an embodiment, incident radiation 500 may pass through a sequence of filtering or conversion elements 508 before reaching the digital image sensors 504. Depending on the application, the system can be configured to operate in one of multiple imaging configurations, including diffracted electromagnetic radiation detection, multi-lens imaging configuration, or single-lens imaging configuration. Each of these configurations is designed to maximize imaging efficiency, ensuring that the captured image data maintains high spatial and spectral fidelity.

Overall, the imaging system introduces an innovative approach to high-resolution spectral and X-ray imaging by integrating advanced filter coatings and scintillator materials directly onto the sensors. The elimination of external optical components reduces system complexity, improves thermal stability, and enhances the overall imaging performance, making the system well-suited for applications requiring precise spectral discrimination and high-speed data acquisition.

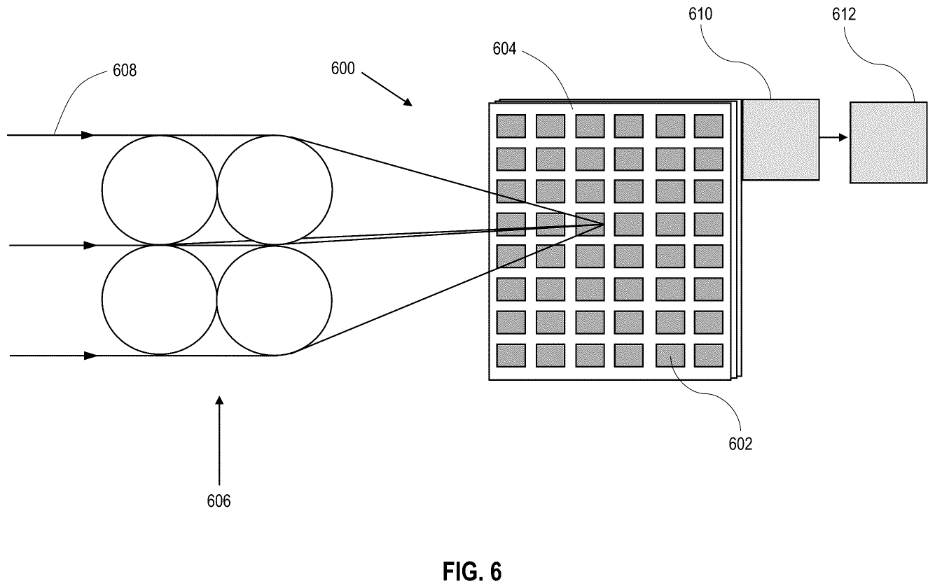

Referring to FIG. 6, there is shown a schematic illustration of a digital image sensor array system 600 with an integrated lens system and processing units, in accordance with an embodiment of the present disclosure. The system 600 is designed to capture high-resolution images while ensuring efficient data aggregation and processing through a combination of tightly packed image sensors, optical elements, and digital processing units.

The digital image sensor array system 600 comprises an array of more than one digital image sensor 602 arranged at a tight inter-sensor spacing on a PCB 604. Each digital image sensor 602 comprises an array of light-sensitive pixels configured to detect incident electromagnetic radiation and convert the detected radiation into a digital signal. The image sensors 602 may be adapted for multispectral or hyperspectral imaging by incorporating optical filters or coatings.

In an embodiment, the system 600 is configured for multiple imaging configurations, including diffracted electromagnetic radiation detection, multi-lens imaging configuration, and single-lens imaging configuration. These configurations enhance the system's adaptability across diverse imaging applications, including biomedical imaging, industrial inspection, and remote sensing.

The system 600 further comprises an optical lens system 606 positioned above the digital image sensor array 602. The optical lens system 606 is designed to focus incident light 608 onto the digital image sensors, ensuring sharp image acquisition with minimal aberrations. In a multi-lens imaging configuration, the system 600 utilizes multiple lenses arranged in a structured array, where each lens directs light onto a corresponding digital image sensor 602. This configuration improves spatial resolution and enables high-quality image reconstruction.

In an embodiment, the system 600 incorporates a first digital processing unit 610, which is operatively connected to the digital image sensors 602 via a plurality of electrical traces patterned on the PCB 604. The first digital processing unit 610 is responsible for receiving digital signals from the image sensors 602, aggregating the received signals into a structured set of digital image data, and performing pre-processing operations such as noise reduction, image alignment, and region-of-interest selection.

In another embodiment, the first digital processing unit 610 comprises one or more FPGAs mounted on a secondary printed circuit board (not shown), which is electrically connected to the primary PCB 604 via high-speed electrical connectors. The FPGA-based processing architecture enables real-time data aggregation, frame synchronization, and computational imaging enhancements.

The system 600 further comprises a second digital processing unit 612, which is configured to receive the pre-processed image data from the first digital processing unit 610. The second digital processing unit 612 performs advanced computational tasks such as object detection, high-resolution image stitching, and data compression. The second digital processing unit 612 may be implemented as a desktop computer, a secondary FPGA-based system, a microcontroller, or a graphics processing unit (GPU).

In an embodiment, the digital image sensor array 602 and the first digital processing unit 610 are thermally managed through the inclusion of a multi-layer PCB structure. The PCB 604 comprises a plurality of high-speed electrical traces distributed over multiple layers, wherein each layer is sandwiched between ground planes that serve as heat sinks to reduce temperature rise in the digital image sensors 602. This thermal management strategy ensures optimal sensor performance and minimizes the risk of thermal noise affecting image quality.

Additionally, the system 600 is designed to support synchronized multi-sensor imaging, wherein the aggregated set of digital image data comprises multiple image frames acquired as a function of time, forming one or more video streams. This feature enables real-time imaging applications, such as industrial quality inspection, motion tracking, and medical imaging.

Overall, the image sensor array system 600 integrates tightly packed digital image sensors, a structured optical lens system, FPGA-based processing units, and a high-speed thermal management PCB architecture. This innovative design ensures high-resolution imaging, efficient data processing, and enhanced computational capabilities across various imaging applications.

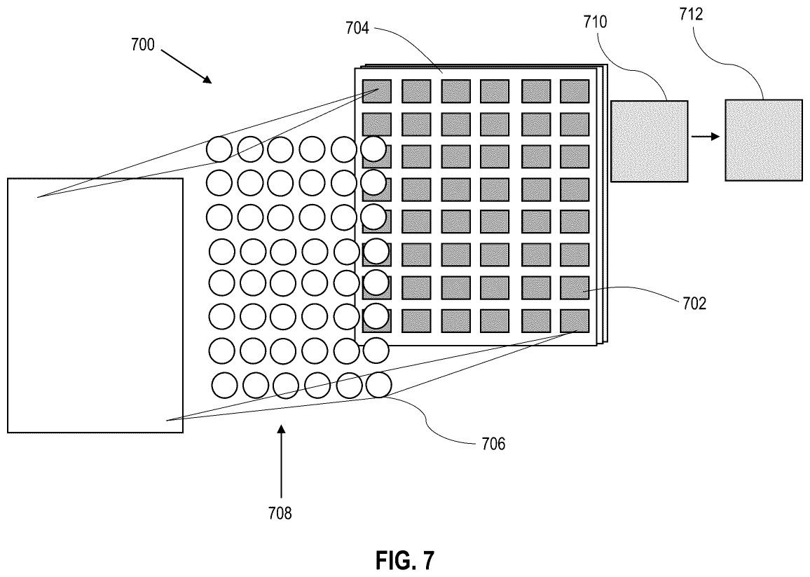

Referring to FIG. 7, there is shown a schematic illustration of an image sensor array system 700 with an integrated lens system 708 and processing units 710-712, in accordance with an embodiment of the present disclosure. The system 700 is designed to capture high-resolution images while ensuring efficient data aggregation and processing through a combination of tightly packed image sensors, optical elements, and digital processing units.

The image sensor array system 700 comprises an array of more than one digital image sensor 702 arranged at a tight inter-sensor spacing on a PCB 704. Each digital image sensor 702 comprises an array of light-sensitive pixels configured to detect incident electromagnetic radiation 706 and convert the detected radiation into a digital signal. The image sensors 702 may be adapted for multispectral or hyperspectral imaging by incorporating optical filters or coatings.

The system 700 further comprises an optical lens system 708 positioned above the digital image sensor array 702. The optical lens system 708 is designed to focus incident light onto the digital image sensors 702, ensuring sharp image acquisition with minimal aberrations. In a multi-lens imaging configuration, the system utilizes multiple lenses arranged in a structured array, where each lens directs light onto a corresponding digital image sensor 702. This configuration improves spatial resolution and enables high-quality image reconstruction.

In an embodiment, the system 700 incorporates a first digital processing unit 710, which is operatively connected to the digital image sensors 702 via a plurality of electrical traces patterned on the PCB 704. The first digital processing unit 710 is responsible for receiving digital signals from the image sensors 702, aggregating the received signals into a structured set of digital image data, and performing pre-processing operations such as noise reduction, image alignment, and region-of-interest selection.

The first digital processing unit 710 comprises one or more FPGAs mounted on a secondary printed circuit board 712, which is electrically connected to the primary PCB 704 via high-speed electrical connectors. The FPGA-based processing architecture enables real-time data aggregation, frame synchronization, and computational imaging enhancements.

The system 700 further comprises a second digital processing unit 712, which is configured to receive the pre-processed image data from the first digital processing unit 710. The second digital processing unit 712 performs advanced computational tasks such as object detection, high-resolution image stitching, and data compression. The second digital processing unit 712 may be implemented as a desktop computer, a secondary FPGA-based system, a microcontroller, or a graphics processing unit (GPU).

The digital image sensor array 702 and the first digital processing unit 710 are thermally managed through the inclusion of a multi-layer PCB structure. The PCB 704 comprises a plurality of high-speed electrical traces, which are distributed over multiple layers, wherein each layer is sandwiched between ground planes that serve as heat sinks to reduce temperature rise in the digital image sensors 702. This thermal management strategy ensures optimal sensor performance and minimizes the risk of thermal noise affecting image quality.

Additionally, the system 700 is designed to support synchronized multi-sensor imaging, wherein the aggregated set of digital image data comprises multiple image frames acquired as a function of time, forming one or more video streams. This feature enables real-time imaging applications, such as industrial quality inspection, motion tracking, and medical imaging.

Overall, the image sensor array system 700 integrates tightly packed digital image sensors, a structured optical lens system, FPGA-based processing units, and a high-speed thermal management PCB architecture. This innovative design ensures high-resolution imaging, efficient data processing, and enhanced computational capabilities across various imaging applications.

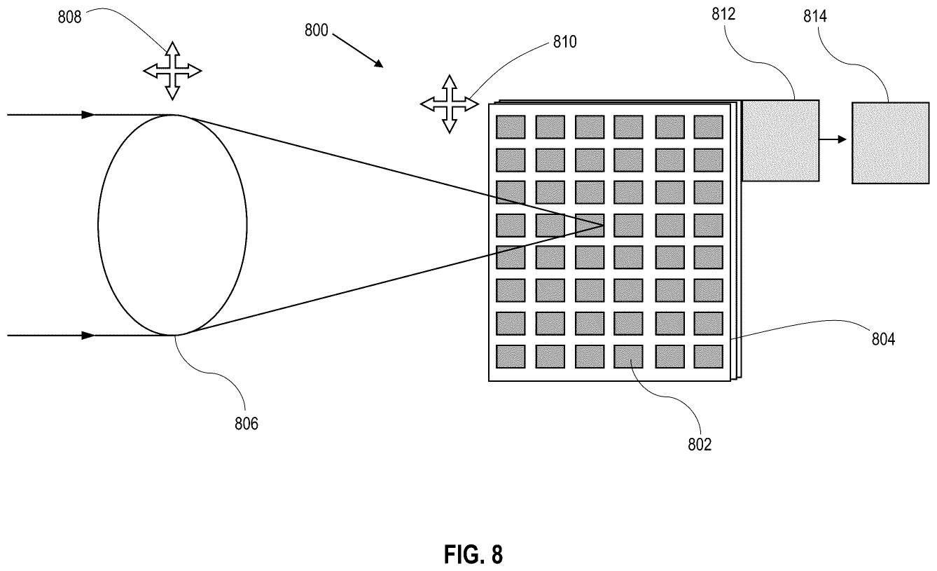

Referring to FIG. 8, there is shown a schematic diagram illustrating an image sensor array system 800 with a microlens array 806 and processing units 812-814, in accordance with an embodiment of the present disclosure. The system 800 enhances image acquisition by utilizing a structured microlens array that optimally directs light onto individual image sensors within the array, improving spatial resolution, light efficiency, and imaging uniformity.

The image sensor array system 800 comprises an array of more than one digital image sensor 802 arranged at a tight inter-sensor spacing on a PCB 804. Each digital image sensor 802 comprises an array of light-sensitive pixels configured to detect incident electromagnetic radiation and convert the detected radiation into a digital signal. The closely spaced arrangement ensures that high-resolution imaging can be achieved with minimal gaps between adjacent imaging areas.

Positioned above the digital image sensor array 802 is a microlens array 806, which consists of multiple microlenses, each corresponding to an individual image sensor or a pixel group. The microlens array 806 is designed to enhance light collection efficiency by directing more incident light onto each sensor element, thereby improving signal-to-noise ratio (SNR) and overall image clarity. The use of a microlens array 806 is particularly beneficial for applications requiring low-light imaging, hyperspectral imaging, or computational photography.

As shown, the image sensor array system 800 comprises adjustment mechanisms 808-810 that enable precise movement of the microlens array 806 relative to the digital image sensor array 802. These mechanisms 808-810 allow for fine alignment adjustments to correct optical aberrations, ensure uniform light distribution, and optimize focal alignment between the microlenses and the corresponding sensor pixels. The adjustment mechanisms 808-810 may include electromechanical actuators, piezoelectric positioning elements, or micro-scale linear motion guides that allow controlled translational shifts of the microlens array along the X-Y plane. Such a mechanism ensures that each microlens properly directs incident light onto the corresponding sensor, enhancing optical efficiency and minimizing image artifacts caused by misalignment.

The system 800 further comprises a first digital processing unit 812, which is operatively connected to the digital image sensors 802 via a plurality of electrical traces patterned on the PCB 804. The first digital processing unit 812 receives the digital signals from the image sensors 802, aggregates them into structured digital image data, and performs pre-processing operations such as noise reduction, exposure balancing, and image alignment.

In an embodiment, the first digital processing unit 812 comprises one or more FPGAs mounted on a secondary printed circuit board (not shown), which is electrically connected to the primary PCB 804 via high-speed electrical connectors. The FPGA-based processing architecture enables real-time computational imaging, allowing for tasks such as high-speed image stitching, real-time object detection, and adaptive exposure control.

The system 800 further comprises a second digital processing unit 814, configured to receive the pre-processed image data from the first digital processing unit 812 for further processing and digital storage. The second digital processing unit 814 is responsible for executing advanced image processing tasks, including multi-frame averaging, image enhancement, and real-time machine vision applications. The second digital processing unit 814 may be implemented as a desktop computer, microcontroller, or graphics processing unit (GPU).

The digital image sensor array 802 and the first digital processing unit 812 are thermally managed through a multi-layer PCB structure. The PCB 804 comprises multiple layers of high-speed electrical traces, which are distributed across different planes, with each layer sandwiched between ground planes that serve as heat sinks. This structure effectively reduces temperature buildup and mitigates thermal noise within the image sensors.

Additionally, the system 800 supports multi-sensor synchronization, allowing multiple image frames to be captured as a function of time, forming one or more video streams. This capability is useful in applications such as medical imaging, high-speed industrial inspection, and motion tracking.

Overall, the image sensor array system 800 integrates a structured microlens array, high-speed FPGA-based processing, and an advanced multi-layer PCB structure to enable high-resolution, high-speed imaging with improved light efficiency.

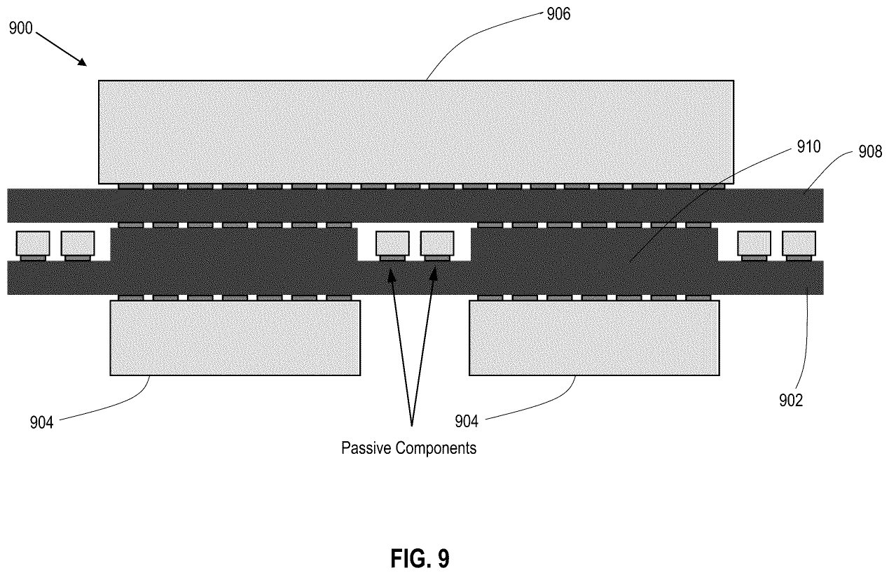

Referring to FIG. 9, there is shown a cross-sectional view of a folded PCB design 900 incorporating a compact arrangement of digital image sensors 904 and a first digital processing unit 906, in accordance with an embodiment of the present disclosure. The system 900 is designed to minimize the overall PCB footprint while ensuring efficient high-speed data transmission and thermal management.

The system 900 comprises a primary PCB 902 upon which an array of more than one digital image sensor 904 is mounted at a tight inter-sensor spacing. The folded PCB architecture allows the first digital processing unit 906, which may be implemented as one or more FPGAs, to be positioned on a secondary PCB 908 that is electrically connected to the primary PCB 902 via high-speed electrical connectors 910.

The folded PCB configuration enhances signal integrity by reducing the trace length between the image sensors 904 and the first digital processing unit 906. This reduction minimizes electromagnetic interference (EMI) and enhances high-speed data transmission efficiency. Additionally, the stacked arrangement improves thermal isolation, ensuring that heat generated by the FPGA does not adversely impact the performance of the digital image sensors.

In an embodiment, the multi-layer PCB structure incorporates multiple ground planes, which serve as heat sinks to efficiently dissipate thermal energy. The electrical traces carrying high-speed digital image data are distributed across separate PCB layers to minimize signal crosstalk and transmission losses.

Overall, the folded PCB architecture 900 optimizes spatial efficiency, thermal management, and data transmission performance, making it highly suitable for high-speed imaging applications requiring dense sensor integration.

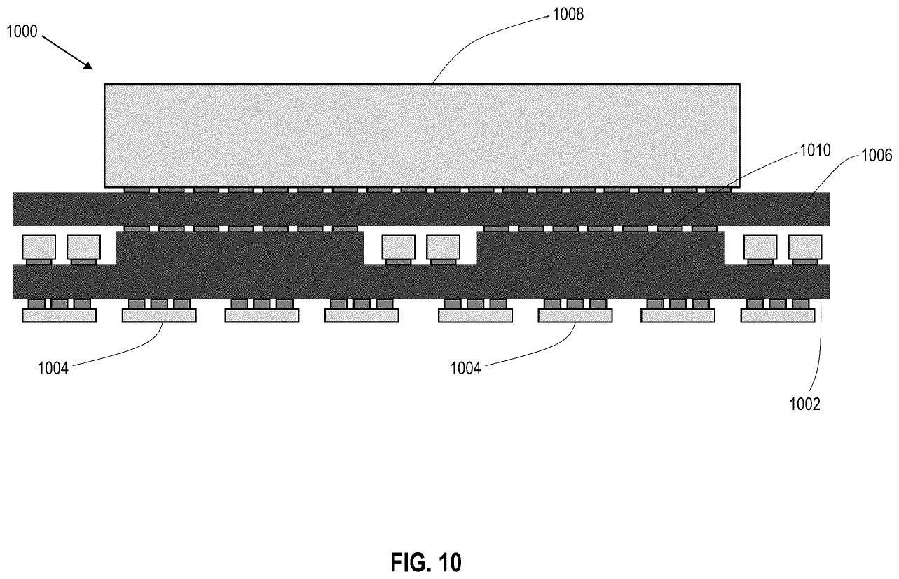

Referring to FIG. 10, there is shown a cross-sectional view of a folded PCB design 1000 incorporating multiple digital image sensors 1004 and an FPGA-based first digital processing unit 1008, in accordance with an embodiment of the present disclosure. The system 1000 leverages advanced high-density PCB stacking to achieve a highly compact and efficient layout for real-time image processing.

The system 1000 features a primary PCB 1002, which houses an array of more than one digital image sensor 1004, arranged in a tight inter-sensor spacing configuration. A secondary PCB 1006, stacked adjacent to the primary PCB 1002, supports the first digital processing unit 1008, implemented as one or more FPGAs.

The high-speed electrical connectors 1010 establish a direct link between the digital image sensors 1004 and the first digital processing unit 1008, ensuring minimal signal latency and high-fidelity data transmission. The PCB structure is designed to include multiple layers of electrical traces, wherein each layer is sandwiched between ground planes to facilitate thermal dissipation and noise isolation.

The folded PCB layout enhances thermal performance, as heat-sensitive components such as the digital image sensors 1004 are thermally isolated from the first digital processing unit 1008. This isolation reduces thermal-induced noise, ensuring that image quality remains unaffected by FPGA heat dissipation.

Overall, the system 1000 demonstrates a highly optimized folded PCB design, integrating FPGA-based real-time image processing, efficient thermal management, and low-latency high-speed data transmission, making it ideal for scalable high-resolution imaging applications.

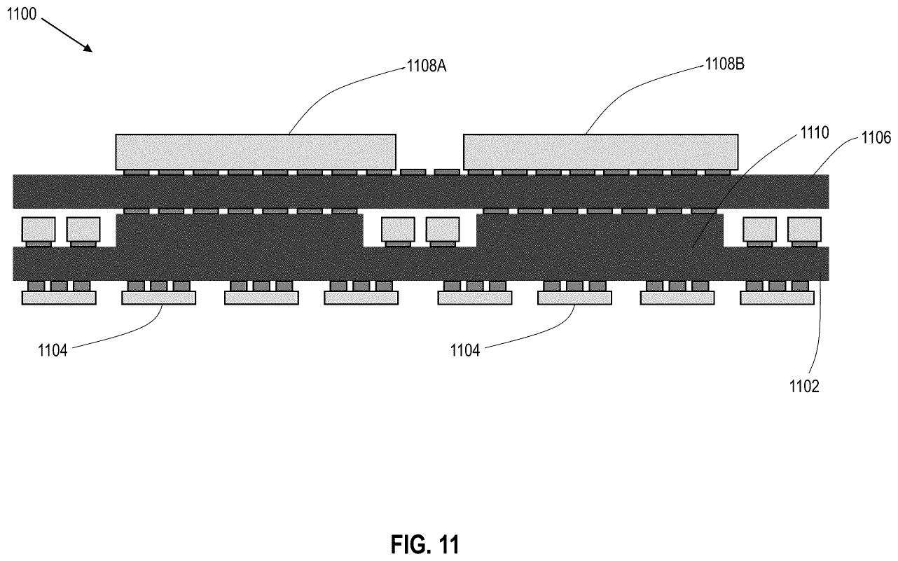

Referring to FIG. 11, there is shown a cross-sectional view of a folded PCB design 1100 incorporating multiple digital image sensors 1104 and a dual FPGA-based first digital processing unit 1108A-B, in accordance with an embodiment of the present disclosure. The system 1100 is designed to handle increased data throughput and high-performance imaging tasks.

The primary PCB 1102 is configured to house an array of more than one digital image sensor 1104 at tight inter-sensor spacing. Mounted on a secondary PCB 1106 are two first digital processing units 1108A and 1108B, which operate as parallel processing nodes to simultaneously handle multiple high-speed image streams.

The high-speed electrical connectors 1110 link the digital image sensors 1104 to the dual first digital processing units 1108A and 1108B, ensuring efficient real-time processing and low-latency image aggregation. The PCB architecture incorporates multiple layers of high-speed electrical traces, wherein each layer is shielded by ground planes to reduce EMI and signal losses.

By utilizing a dual FPGA processing configuration, the system 1100 is capable of performing real-time image compression, AI-based feature extraction, and multi-sensor synchronization. The second digital processing unit, implemented as a high-performance computing platform, receives the aggregated data for final processing and digital storage.

Overall, the system 1100 a scalable, high-speed imaging platform, integrating parallel FPGA-based processing, optimized data transmission, and robust thermal management, making it ideal for high-throughput machine vision and real-time computational imaging applications.

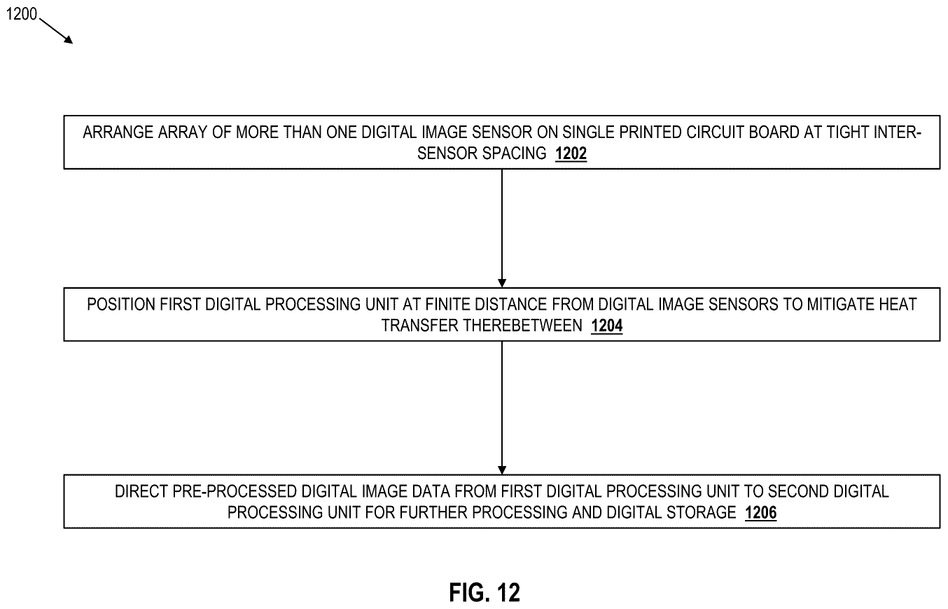

Referring to FIG. 12, there is shown a flowchart 1200 of a method of digital imaging, in accordance with an embodiment of the present disclosure. At step 1202, an array of more than one digital image sensor is arranged on a single PCB at a tight inter-sensor spacing. The inter-sensor spacing is less than a width of two adjacent image sensors and wherein each digital image sensor comprises an array of light sensitive pixels configured to detect incident electromagnetic radiation and convert the detected electromagnetic radiation into a digital signal. At step 1204, a first digital processing unit is positioned at a finite distance from the digital image sensors to mitigate heat transfer therebetween. The first digital processing unit is configured to receive the digital signals from the digital image sensors via electrical traces patterned on the PCB and aggregate the received digital signals into a set of digital image data. At step 1206, the set of digital image data is pre-processed and the pre-processed digital image data is directed from the first digital processing unit to a second digital processing unit for further processing and digital storage.

### General Definitions

The term “digital imaging system” as used herein relates to an integrated system that comprises multiple digital image sensors, associated processing units, and supporting circuitry configured to capture, process, and store images derived from incident electromagnetic radiation.

The term “digital image sensor” as used herein relates to an electronic sensor comprising an array of light sensitive pixels that detect incident electromagnetic radiation and convert the detected radiation into a digital signal.

The term “printed circuit board” or “PCB” as used herein relates to a substrate that supports and electrically interconnects various electronic components, including digital image sensors and processing units, via patterned electrical traces.

The term “inter-sensor spacing” as used herein relates to the physical distance between adjacent digital image sensors on the PCB, wherein such spacing is less than the width of two adjacent sensors to enable a high-density arrangement.

The term “light sensitive pixels” as used herein relates to the individual sensor elements within a digital image sensor that convert incident electromagnetic radiation into electrical signals.

The term “incident electromagnetic radiation” as used herein relates to electromagnetic energy, which may include visible, ultraviolet, near-infrared, or infrared light, that impinges upon the digital image sensors for detection.

The term “digital signal” as used herein relates to an electrical signal generated by a digital image sensor that represents the quantized form of the detected electromagnetic radiation.

The term “first digital processing unit” as used herein relates to the processing module that is operatively connected to the digital image sensors via electrical traces, and is responsible for receiving digital signals, aggregating them into a set of digital image data, and pre-processing such data while being positioned to minimize heat transfer from the sensors.

The term “electrical traces” as used herein relate to the conductive pathways patterned on the printed circuit board that electrically interconnect the digital image sensors with the processing units and convey digital signals and control signals.

The term “set of digital image data” as used herein relates to the collection of processed digital signals, which may include multiple image frames, that represent the captured images from the sensor array.

The term “pre-process” as used herein relates to the initial stage of digital image data treatment, which may involve signal conditioning, noise reduction, and data aggregation prior to further processing or storage.

The term “second digital processing unit” as used herein relates to the processing module that receives the pre-processed digital image data from the first digital processing unit for further processing and digital storage.

The term “digital storage” as used herein relates to the memory or storage medium where processed digital image data is stored for retrieval, display, or further analysis.

The term “digital control signals” as used herein relate to the electronic signals transmitted over electrical traces that define or adjust the operating properties of the digital image sensors.

The term “operating properties” as used herein relate to the configurable parameters of the digital image sensors, such as exposure time, gain, frame rate, and pixel sub-sampling strategies.

The term “filter” as used herein relates to an optical or material component applied to a digital image sensor to selectively pass or block predetermined components of the incident electromagnetic radiation.

The term “fluorescence emission filter” as used herein relates to a type of filter that selectively transmits wavelengths corresponding to fluorescence emission from the incident electromagnetic radiation.

The term “color filter” as used herein relates to a color filter configuration wherein alternating filters are arranged in a mosaic pattern on the sensor to capture color information in accordance with the Bayer pattern.

The term “predetermined spectral component” as used herein relates to a specific portion or band of the electromagnetic spectrum that is selected for transmission through a filter applied to a digital image sensor.

The term “homogeneous filter material” as used herein relates to a filter material that is uniformly applied across the entire surface of a digital image sensor to affect the spectral properties of the detected radiation.

The term “inhomogeneous filter material” as used herein relates to a filter material that is non-uniformly applied across the digital image sensor, potentially providing variable filtering characteristics over different regions of the sensor.

The term “spectral manner” as used herein relates to the filtering of incident electromagnetic radiation based on its wavelength characteristics.

The term “polarimetric manner” as used herein relates to the filtering or modification of incident electromagnetic radiation based on its polarization properties.

The term “scintillator material” as used herein relates to a material applied to a digital image sensor that converts incident X-ray radiation into fluorescence emission, which is then detected by the sensor.

The term “X-ray radiation” as used herein relates to high-energy electromagnetic radiation, which, when incident upon a scintillator material, is converted into a lower energy fluorescent signal detectable by a digital image sensor.

The term “field-programmable gate arrays” or “FPGAs” as used herein relate to reconfigurable integrated circuits used as part of the first digital processing unit to enable high-speed data aggregation, processing, and routing.

The term “secondary printed circuit board” as used herein relates to an auxiliary substrate on which the first digital processing unit is mounted, and which is electrically connected to the sensor-bearing PCB via high-speed electrical connectors.

The term “high-speed electrical connectors” as used herein relate to the connectors that provide rapid and reliable electrical communication between the secondary printed circuit board and the primary PCB bearing the digital image sensors.

The term “multi-layer stackup” as used herein relates to the layered construction of a printed circuit board that contains multiple layers of high-speed electrical traces, each separated by insulating materials and sandwiched between ground planes.

The term “high-speed electrical traces” as used herein relate to the conductive pathways designed to carry digital signals at high frequencies with minimal loss and interference across the layers of the printed circuit board.

The term “ground planes” as used herein relate to conductive layers within the multi-layer stackup of the printed circuit board that serve as reference potentials and heat sinks to reduce temperature rise in the digital image sensors.

The term “heat sinks” as used herein relate to components or structures, such as ground planes or dedicated devices, that dissipate heat away from the digital image sensors and associated circuitry to maintain optimal operating temperatures.

The term “image frames” as used herein relate to successive digital images captured over time by the digital image sensors, which together may constitute a dynamic sequence or video stream.

The term “video streams” as used herein relate to continuous sequences of image frames that represent moving images, derived from the aggregated set of digital image data.

The term “noise reduction” as used herein relates to the process of eliminating or reducing unwanted signal variations (noise) in the digital image data to improve image clarity.

The term “lossless image compression” as used herein relates to a data compression technique that reduces the size of digital image data without any loss of information, enabling exact reconstruction of the original image.

The term “lossy image compression” as used herein relates to a data compression technique that reduces the size of digital image data by selectively discarding certain information, resulting in an approximation of the original image.

The term “region-of-interest selection” as used herein relates to the identification and extraction of specific portions of an image that are of particular interest for further processing or analysis.

The term “feature selection” as used herein relates to the process of identifying and extracting significant attributes or patterns from digital image data that are useful for image analysis and interpretation.

The term “image comparison” as used herein relates to the evaluation and analysis of two or more images to determine similarities, differences, or changes between them.

The term “image stitching” as used herein relates to the process of combining multiple digital images with overlapping fields of view into a single, larger composite image.

The term “digital instructions” as used herein relate to commands or control signals transmitted between processing units to define or modify processing tasks and configurations.

The term “programmable logical blocks” as used herein relate to configurable units within the first digital processing unit that are created or modified in response to digital instructions, enabling tailored processing functions.

The term “imaging configurations” as used herein relate to the various system arrangements or setups by which the digital imaging system is adapted to capture images, such as diffracted electromagnetic radiation detection, multi-lens imaging, or single-lens imaging.

The term “diffracted electromagnetic radiation detection” as used herein relates to an imaging configuration in which the system is arranged to capture and process electromagnetic radiation that has been diffracted, typically to analyze material properties or structures.

The term “multi-lens imaging configuration” as used herein relates to an imaging setup in which multiple lenses are used to capture slightly shifted or overlapping images from different perspectives, which are then aggregated to form a high-resolution composite image.

The term “single-lens imaging configuration” as used herein relates to an imaging setup in which a single primary lens is used to project an image onto the digital image sensor array, potentially with the sensor array or lens being adjusted to capture different portions of the scene.

The term “contiguous object plane” as used herein relates to a continuous region or area from which the digital imaging system captures image data, ensuring that the captured images represent an undivided view of the object or scene.

The term “three-dimensional structure” as used herein relates to a PCB architecture that incorporates multiple layers and/or boards, such as a sensor board and a secondary processing board, arranged in a stacked configuration.

The term “sensor board” as used herein relates to the printed circuit board or portion thereof that is dedicated to mounting the digital image sensors.

The term “secondary processing board” as used herein relates to an auxiliary board onto which the first digital processing unit is mounted, thereby facilitating close proximity to the sensor board while maintaining effective separation for thermal and layout considerations.

The term “milled channels” as used herein relate to recessed or routed areas formed in a printed circuit board designed to accommodate passive components and facilitate improved component placement and thermal management.

The term “passive components” as used herein relate to non-active electronic components, such as resistors, capacitors, and inductors, that are mounted on the printed circuit board to support the operation of active components like sensors and processing units.

The term “exposed pads” as used herein relate to conductive areas on the printed circuit board that are left uncovered by solder mask or components to allow for electrical connections, such as those used to attach a secondary processing board.

The term “thermal management mechanism” as used herein relates to a system or set of components designed to mitigate heat accumulation within the digital imaging system, thereby ensuring stable operation and preventing overheating.

The term “exposed copper regions” as used herein relate to areas of copper on the printed circuit board that are not covered by solder mask, which serve to dissipate heat by increasing thermal conduction.

The term “forced air cooling” as used herein relates to the use of fans or blowers to direct airflow over critical components, thereby enhancing heat dissipation and maintaining optimal operating temperatures.

The term “heat pipes” as used herein relate to sealed thermal conduction devices that transfer heat from one area of the system to another, providing an efficient means to remove excess heat from densely packed electronic components.

The term “method of digital imaging” as used herein relates to a sequence of steps for arranging digital image sensors on a printed circuit board, capturing electromagnetic radiation, processing the resulting digital signals, and storing the processed image data, thereby achieving efficient and thermally managed image acquisition and processing.

It will be appreciated that various aspects of the disclosure may be embodied as a method, system, computer readable medium, and/or computer program product. Aspects of the disclosure may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the disclosure may take the form of a computer program product on a computer-usable storage medium having computer-usable program code embodied in the medium.

Any suitable computer useable medium may be utilized for software aspects of the disclosure. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific embodiments (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium may even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the disclosure may be written in an object-oriented programming language such as Java, Smalltalk, C++ or the like. However, the program code for carrying out operations of the disclosure may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The disclosure may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network includes wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The disclosure may be applied to any wireless/wireline communications network, regardless of physical componentry, physical configuration, or communications standard(s).

In some aspects, wireless communication interfaces may include, but are not limited to, an Intranet connection, Internet, Personal Area Networks (PANs) for the exchange of data over short distances, e.g., using short-wavelength radio transmissions in the industrial, scientific, and medical (ISM) band ISM band from 2400-2480 MHZ) from fixed and mobile devices (e.g., Bluetooth® technology), wireless fidelity (Wi-Fi), Wi-Max, IEEE 802.1 1 technology, radio frequency (RF), Infrared Data Association (IrDA) compatible protocols, Local Area Networks (LANs), Wide Area Networks (WANs), Shared Wireless Access Protocol (SWAP), Zigbee, Near-Field Communication (NFC), LiFi, 5G, any combinations thereof, and other types of wireless networking protocols.

Certain aspects of disclosure are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the disclosure.

Any of a variety of light sources may be used to provide the excitation and/or imaging light, including but not limited to, tungsten lamps, tungsten-halogen lamps, arc lamps, lasers, light emitting diodes (LEDs), or laser diodes.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present disclosure. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the disclosure. However, the disclosure should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the disclosure as defined by the following claims.

1. A digital imaging system, the system comprising:
a) an array of more than one digital image sensor arranged on a single printed circuit board (PCB) at a tight inter-sensor spacing, wherein the inter-sensor spacing is less than a width of two adjacent image sensors and wherein each digital image sensor comprises an array of light sensitive pixels configured to:
b) detect incident electromagnetic radiation; and
c) convert the detected electromagnetic radiation into a digital signal;
d) a first digital processing unit operatively connected to the plurality of electrical traces, wherein the first digital processing unit is positioned at a finite distance from the digital image sensors to mitigate heat transfer therebetween and wherein the first digital processing unit is configured to:
e) receive the digital signals from the digital image sensors;
f) aggregate the received digital signals into a set of digital image data; and
g) pre-process the set of digital image data; and
h) a second digital processing unit configured to receive the pre-processed digital image data from the first digital processing unit for further processing and digital storage.

2. The digital imaging system of claim 1, wherein the printed circuit board comprises a plurality of electrical traces patterned thereon, wherein the plurality of electrical traces is electrically coupled to each of the digital image sensors and wherein each electrical trace is configured to carry the digital signals representing the detected electromagnetic radiation and one or more digital control signals that define operating properties of the digital image sensors.

3. The digital imaging system of claim 1, wherein each digital image sensor is configured to detect incident electromagnetic radiation associated with visible, ultraviolet, near-infrared or infrared portions of electromagnetic spectrum.

4. The digital imaging system of claim 1, wherein at least one digital image sensor is coated with a filter selected from the group consisting of: a fluorescence emission filter and a color filter arranged in a Bayer pattern and wherein the filter selectively passes a predetermined spectral component of the incident electromagnetic radiation.

5. The digital imaging system of claim 1, wherein at least one digital image sensor is coated with a homogeneous or inhomogeneous filter material covering the entire image sensor and wherein the homogeneous or inhomogeneous filter material filters the incident electromagnetic radiation in a spectral manner, a polarimetric manner or both.

6. The digital imaging system of claim 1, wherein at least one digital image sensor is coated with a scintillator material configured to convert incident X-ray radiation into fluorescence emission that is subsequently detected by the digital image sensor.

7. The digital imaging system of claim 1, wherein the first digital processing unit comprises one or more field-programmable gate arrays (FPGAs) mounted on a secondary printed circuit board that is electrically connected via high-speed electrical connectors to the PCB bearing the array of more than one digital image sensor.

8. The digital imaging system of claim 1, wherein the printed circuit board comprises a multi-layer stackup having a plurality of high-speed electrical traces distributed over the layers and wherein each layer is sandwiched between ground planes that serve as heat sinks to reduce temperature rise in the digital image sensors.

9. The digital imaging system of claim 1, wherein the aggregated set of digital image data comprises multiple image frames acquired as a function of time and wherein the multiple image frames acquired as the function of time constitute one or more video streams.

10. The digital imaging system of claim 1, wherein the first digital processing unit is further configured to perform digital image processing selected from a group consisting of: noise reduction, lossless image compression, lossy image compression, region-of-interest selection, feature selection, image comparison and image stitching.

11. The digital imaging system of claim 1, wherein the first digital processing unit is further configured to send one or more digital control signals to the digital image sensors to define operating properties thereof and wherein the second digital processing unit is further configured to send digital instructions to the first digital processing unit for forming programmable logical blocks therein.

12. The digital imaging system of claim 1, wherein the system is configured for one of multiple imaging configurations selected from a group consisting of: diffracted electromagnetic radiation detection, multi-lens imaging configuration and single-lens imaging configuration and wherein the imaging configuration provides a high-resolution image from a contiguous object plane of interest.

13. The digital imaging system of claim 1, wherein the printed circuit board comprises a three-dimensional structure including a sensor board and a secondary processing board, wherein the sensor board has a top side for mounting the digital image sensors and a bottom side having milled channels for accommodating passive components and wherein the secondary processing board, onto which the first digital processing unit is mounted is soldered onto exposed pads in unmilled sections of the sensor board.

14. The digital imaging system of claim 1, the system further comprising a thermal management mechanism configured to mitigate heat accumulation at the digital image sensors and along the electrical traces and wherein the thermal management mechanism comprises at least one of a group consisting of: multiple ground planes, exposed copper regions, heat sinks, forced air cooling and an array of heat pipes.

15. A method of digital imaging, the method comprising:
a) arranging an array of more than one digital image sensor on a single printed circuit board (PCB) at a tight inter-sensor spacing, wherein the inter-sensor spacing is less than a width of two adjacent image sensors and wherein each digital image sensor comprises an array of light sensitive pixels configured to:
b) detect incident electromagnetic radiation; and
c) convert the detected electromagnetic radiation into a digital signal;
d) positioning a first digital processing unit at a finite distance from the digital image sensors to mitigate heat transfer therebetween, wherein the first digital processing unit is configured to:
e) receive the digital signals from the digital image sensors via electrical traces patterned on the PCB; and
f) aggregate the received digital signals into a set of digital image data; and pre-process the set of digital image data; and
g) directing the pre-processed digital image data from the first digital processing unit to a second digital processing unit for further processing and digital storage.
